(19) United States
(12) Patent Application Publication
(10) Pub. No.: US 2019/0222103 A1
(43) Pub. Date: Jul. 18, 2019

(54) DECENTRALISED ELECTRIC ROTARY ACTUATOR AND ASSOCIATED METHODOLOGY FOR NETWORKING OF MOTION SYSTEMS

(71) Applicant: GRIP OFFSHORE AS, Stavanger (NO)

(72) Inventors: Bjarte NEDREHAGEN, Stavanger (NO); Øivind FRØILAND, Sandnes (NO)

(73) Assignee: Grip Offshore AS, Stavanger (NO)

(21) Appl. No.: 16/301,622

(22) PCT Filed: May 22, 2017
(86) PCT No.: PCT/EP2017/062304

§ 371 Date: Nov. 14, 2018

(30) Foreign Application Priority Data
May 22, 2016 (NO) 20160853

(51) Int. Cl. H02K 11/35; H02K 5/22; H02K 7/08; H02K 7/116; H02K 11/33; H02K 13/00; F16H 49/00; F16H 1/28; F16H 1/32; B25J 9/10; B25J 19/00

(52) U.S. Cl. CPC H02K 11/35; H02K 5/225; H02K 7/088; H02K 7/116; H02K 11/33; F16H 2049/006; F16H 49/001; F16H 1/28; F16H 1/32; B25J 9/1025; B25J 19/0041; H02K 13/003

(57) ABSTRACT

This disclosure relates to a decentralized electric rotating actuator with high torque output. Furthermore, the actuator disclosed may be configured for transmission of electrical power and communications through a network. The actuator includes, actuator housing 1, actuator shaft 2, power module 4, engine (electrical motor) 6a, a motor driver 6 including network module 5 or separate network module 35 and motor driver 36. The power (voltage) and communication signals of the actuator can be transferred internally in both directions via connection means, which may be slip rings or other appropriate connection means 3, between the actuator housing 1 and the actuator shaft 2 at connection points 14, 15. Power and communication signals can be continuously input to or output from the actuator of this disclosure via any connection port 17 located on the housing 1 or shaft 2; allowing the formation of a network with other actuators or similar devices. An increased torque ratio may be achieved by placing an electric motor 6a with external rotor 6b in combination with a strain wave gearing system 18 directly, or in connection, with a planetary gearing system 11 in which the electric motor 6a may be located in the centre of the strain wave gearing system 18. The electric motor 6a with external rotor 6b, with an oval shape and associated oval bearings 38, may be an integral part of the wave generator. Alternatively, the electric motor 6a with external rotor 6b may be present as a sun gear 21 with motor rotor running continuously. A hollow shaft construction may serve to maximise the space available within the actuator and to reduce the size by providing the necessary circuitry as well as other components in the most efficient and space saving manner.

### TECHNICAL FIELD

This disclosure relates to a decentralized electric rotating actuator with high torque output. Furthermore, the actuator disclosed may be configured for transmission of electrical power and communications through a network. The actuator may also be bidirectional in that power and communications can be supplied via either the actuator housing or via the actuator shaft and may be particularly useful in networks with identical actuators, with other corresponding actuators or in conjunction with other network-based modules. Communications may be supplied from/to the actuator to/from other devices within the network by fibre optics or other appropriate means such as standard cabling.

### BACKGROUND ART

At present, hydraulic and pneumatic rotating actuators, which are known to be robust and have high power to volume ratios, are the preferred solution for providing increased torque output, in high power networks and automation/motion systems that must withstand great stresses. A high degree of component and network flexibility is desirable, in such networks, in order to make cost-effective changes to automation systems; this is difficult to achieve in hydraulic and pneumatic systems. Today's automation or motion systems are built up of a high number of autonomous subsystems; this provides “rigid” systems with little flexibility, due to the high number of interfaces. The large number of interfaces also provides high complexity in production, commissioning, service and maintenance throughout the system lifetime. In the implementation of hydraulic and pneumatic systems, a number of components including mechanical, piping, voltage supply and a communication network are used; each of which must be automated and controlled by separate physical systems. This makes the automation or motion systems unnecessarily complex and necessitates the need for a high number of integration tests to check that the system is functioning as desired.

Unfortunately, presently available electric actuators which could competitively match the high power and volume conditions, while reducing the network complexity, of hydraulic and pneumatic actuators are not available on the market. Current electrical alternatives wherein cables carry electrical power and communication networks from static components to rotating or moving components, presently fall into one of the following configurations: (a) an actuator with hollow centre shaft for cable continuation; (b) an actuator with its own cable handling system, wherein the cable handling system is encapsulated by and/or consists of moving components on the outside of the actuator construction itself. Cable conduction where the centre hole solution may be used has a finite rotation angle, wherein the cables are twisted around each other by rotation and large rotation angle, in addition to wear on the cable's enclosure, this can lead to short-circuits. Solutions that include their own cable management system often consist of free-standing cables, movable cable channels, enclosed cableway solutions or external slip ring solutions. For free standing cables or movable cableways, the cables are vulnerable and exposed to the environment. In addition, they are bulky as the minimum bending radius of the cable must be considered. Enclosed cableway solutions are specially designed, leading to increased number of components and associated increased costs and cable management systems for unlimited rotation, externally mounted slip ring 3 solutions or wireless solutions are only used if the environment allows.

Some of the above issues have been tackled in, for example, TracLab's two types of actuators which are part of their modular manipulator, Patent Document 3. In TracLab's solution a locking device may be used to tie the actuators together during assembly. The locking device which binds the actuators together transmits mechanical motion, electrical and communications networks to the next part of the manipulator arm. The interface has two plugs which mate with each other; each actuator may be equipped with a plug-in interface at one end and a plug interface at the opposite end, which effectively act as male and female connectors. This solution, however, does not have a tow device (slip ring) between the two main components that can be rotated in relation to each other; thus, electrical power and communication signals cannot be transmitted at continuous rotation. Slip rings offer the ability to transmit power and electrical signals from a stationary to a rotating structure. The use of the actuators seen in TracLab's application may be thus limited to forming a manipulator solution and cannot be used directly in other contexts; particularly not as a building block or hub in larger Automation/motion systems.

Similarly to the solution proposed by TracLab, US Patent Document 1 discusses a modular electro-mechanical system in which several actuators, used to form a robotic leg, are capable of modifying the state of the system in line with a command that is received. The electro-mechanical system of Patent Document 1, however, is not intended to be used for large tasks which would normally be undertaken by hydraulic and pneumatic solutions and is only directed to tasks requiring low torque. As such, the focus is not on the power density of the system.

Furthermore, this solution does not envisage using high DC voltage for power distribution which is then transformed into an operable voltage within the actuator; as only a 48V DC source is used. Similarly to TracLab's solution, continuous rotation cannot be achieved and the axis of rotation is not around the centre axis of the actuator; these features are desirable for providing a flexible system which can reduce the complexity of a control network which can replace hydraulic and pneumatic solutions. Patent Document 2 describes a vehicle steering system with a differential steering actuator with a solid shaft that uses a pancake hydraulic drive. Unfortunately, this system is rather complex, containing a large number of mechanical parts and associated increased costs as well as increased system maintenance.

The problem of simplifying the network topology has been the aim of Siemens development with their electric motor; S120M. The S120M has an integrated motor driver and can be connected in the daisy chain from the actuator housing to actuator housing and the volume of the engine may be large in relation to the power of the output shaft. The downfall, however, with this solution, is that when this motor is used within a control network the cables must be handled by their own systems. Furthermore, the connections with other devices in the network cannot take place at both sides of the rotation of the actuator shaft and housing.

The mentioned solutions cannot currently compete with hydraulic or pneumatic alternatives for power and volume conditions. For example: TracLab's solution may be intended only for the construction of a manipulator arm, and may not be designed for continuous rotation; while Siemens' solution focuses on networking of currently available electric motors which cannot network across the rotational divide or match the capabilities of hydraulic and pneumatic alternatives.

Thus, it is an object of the present disclosure to solve the above problems by providing an actuator for an automation and/or motion control network which enhances development, production, service and maintenance, while enabling transparent system architecture with high freedom for network topology, change and upgrading. The actuator of the present disclosure also provides bidirectional transmission of the electrical and communicational network between moving components, while allowing continuous 360° degree rotation, and could serve to replace hydraulic solutions.

### RELATED ART DOCUMENTS

### Patent Documents

| | |
|---|---|
| Patent Document 1 | US Patent Application Publication |
| | US 2015/321348 A1 |
| Patent Document 2 | US Patent Application Publication |
| | US 2006/213320 A1 |
| Patent Document 3 | US Patent Application Publication |
| | US 2013/0340560 A1 |

### SUMMARY

The actuator includes, actuator housing, actuator shaft, power module, engine (electrical motor), a motor driver including network module or separate network module and motor driver. In any of the disclosed configurations the motor driver may be combined with the power module instead of the network module into one single unit. The power (voltage) and communication signals of the actuator can be transferred internally in both directions via connection means, which may be slip rings or cables or other appropriate connection means, between the actuator housing and the actuator shaft at connection points. The actuator may have one or more of these connection points (points of connection), at which the connection means are located, between the actuator shaft and the actuator housing. These connection means, e.g. slip rings, located inside the actuator at the connection points between the actuator housing and the actuator shaft, may preferably be wireless slip rings which may transfer power and communication signals via an electromagnetic field. Furthermore, the number of connection points may be different from the number of connection ports and each connection point, and thus connection means, may consist of at least two connection lines; a power and communication line. The actuator power (voltage) module isolates the actuator from the connected power source, which may be a power grid, and reduces the voltage supplied to the actuator to an operable voltage level matched to the motor driver and the electric motor. Power and communication signals can be continuously input to or output from the actuator of this disclosure via any of the connection ports; as such the actuator of the present disclosure may form a network with other actuators or similar devices. Communications may be supplied from/to the actuator to/from other devices within the network by fibre optics or other appropriate means such as standard cabling.

The increased torque ratio may be achieved by placing an electric motor with external rotor in combination with a strain wave gearing system directly, or in connection, with a planetary gearing system in which the electric motor may be located in the centre of the strain wave gearing system. The electric motor with external rotor, with an oval shape and associated oval bearings, may be an integral part of the wave generator. Alternatively, the electric motor with external rotor may be present as a sun gear with motor rotor running continuously. A tooth ring may be present around the sun gear outer surface with two or more planet gears in engagement with the inner tooth ring of a flexible spline; thus, forming an oval shape. The flexible spline provides the output of the actuator. The electric motor may be of solid shaft or hollow shaft design and the planet gears used may have smaller diameter than the sun gear. In the configuration, wherein the hollow shaft engine (electric motor) may be used to achieve a compact design, the actuator power (voltage) module, network module, motor driver, may be placed in the centre. This hollow shaft construction serves to maximise the space available within the actuator and to reduce the size by providing the necessary circuitry as well as other components in the most efficient and space saving manner. In one configuration, the wave generator with an asymmetrical oval shape may be used. If the asymmetrical oval shape is used in conjunction with a planetary gearing system, the asymmetrical oval shape of the wave generator may be cancelled using different emphasis on planet gears. The sun gear and planet gears may be of eccentrically cycloidal gearing design or bear gearing design.

### BRIEF DESCRIPTION OF DRAWINGS

FIG. 1 is a diagram illustrating a 3D model example of the external design of actuator;

FIG. 2 is a diagram illustrating the possible locations of connection ports on the two main components of the actuator;

FIG. 3 is a diagram illustrating one possible coupling for two actuators via actuator housing to actuator housing link;

FIG. 4 is a diagram illustrating one possible coupling for two actuators via an actuator shaft to actuator shaft link;

FIG. 5 is a diagram illustrating one possible coupling for two actuators via actuator housing to actuator shaft link;

FIG. 6 is a diagram illustrating one possible coupling for two actuators via an actuator shaft to actuator housing link;

FIG. 7 is a diagram illustrating one possible electric circuitry configuration of the actuator wherein the motor driver and the network module are combined;

FIG. 8 is a diagram illustrating one possible electric circuitry configuration of the actuator wherein the motor driver and the network module are combined;

FIG. 9 is a diagram illustrating another possible construction of an alternative actuator wherein the motor driver and the network module are separate components;

FIG. 10 is a diagram illustrating a cross section and principal structure of the actuator, storage and joining of components, fixing method and mechanical interfaces are presented in detail for the actuator;

FIG. 11 is a diagram illustrating one possible schematic structure of the actuator drive line;

FIG. 12 is a diagram illustrating one possible configuration of the first part of the actuator gearing system;

FIG. 13 is a diagram illustrating the components in the first part of actuator gearing system as integrated into the second part (flexible spline) of the actuator gearing system;

FIG. 14 is a diagram illustrating the second part of the actuator gearing system integrated with the third and final part (actuator housing) of the gearing system;

FIG. 15 is a diagram illustrating a possible schematic structure of alternative actuator drive line;

FIG. 16 is a diagram illustrating the possible configuration of the alternative actuator drive line;

FIG. 17 is a diagram illustrating an exploded overview of two actuator configurations which may be integrated with the actuator housing.

FIG. 18 is a diagram illustrating another example configuration of the actuator drive line which may be integrated with the actuator housing.

FIG. 19 is a diagram illustrating an exploded overview of another actuator configuration.

### DETAILED DESCRIPTION OF THE FIGURES

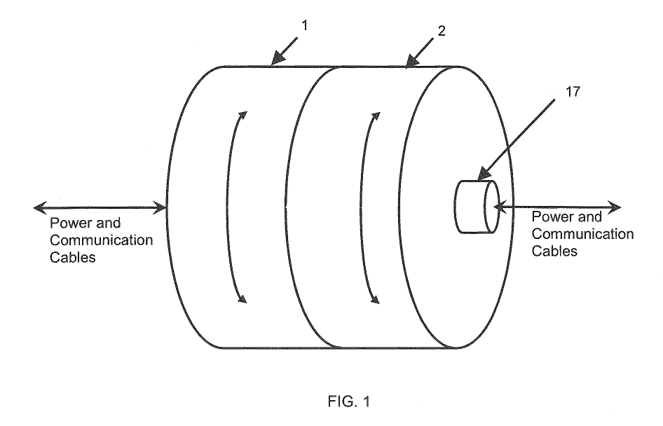

One configuration of the decentralised rotating electrical actuator, capable of generating high torque, for example 20-2000 Nm, can be seen in FIG. 1, wherein the actuator shaft 2 can rotate bidirectionally and independent of the actuator housing 1, around the actuator centre axis 25, as shown in FIG. 1 by the bidirectional arrows. Connection ports 17 are formed on both the static and rotating parts of the actuator, at least one on the static actuator housing 1 and at least one on the rotating actuator shaft 2. These connection ports 17 provide the actuator with electrical power as well as communication signals; these ports 17 may be socket type connections adapted to receive a plug or other electrical connector. Furthermore, they may be standardised to provide improved compatibility for other network devices. One example may be that the communication signal may be used as a control signal for the network and individual components within the motion control devices in the network. The ability to transfer power and communication signals from a connection port 17 on the static actuator housing 1 to a connection port 17 on the rotating actuator shaft 2, to a connection port 17 on the static actuator housing 1 from a connection port 17 on the rotating actuator shaft 2 via the internal circuitry, in particular connection means 3 preferably slip rings, which will be described later, allows for a much simpler actuator and network with no vulnerable cables or slip rings 3 necessary externally.

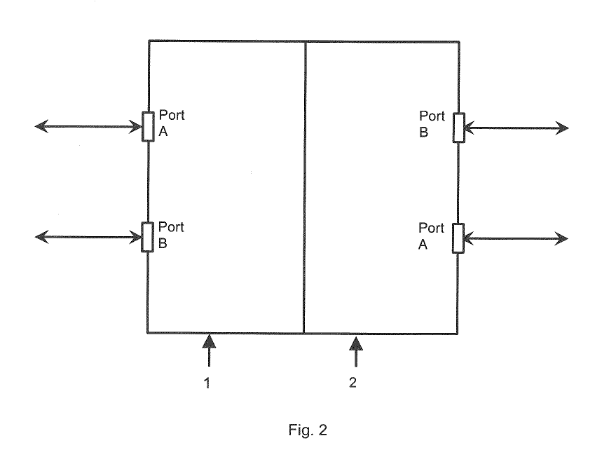

While it is desirable that one connection port 17 be present on the static actuator housing 1 and the rotating actuator shaft 2 of the electrical actuator, a number of further connection ports 17 may also be present on the static actuator housing 1 and the rotating actuator shaft 2; this can be seen in FIG. 2. FIG. 2 depicts two connection ports 17 (“A” and “B”) on each of the actuator housing 1 and the actuator shaft 2, however, it should be understood that the naming of these connection ports 17 “A” and “B” is merely arbitrary and no relationship, beyond the identical construction, is intended between the two “A” ports 17 as well as the two “B” ports 17. These connection ports 17 may be considered as, but not limited to, four separate connection ports 17 with the same configuration, capable of connecting the demonstrated actuator to, in the example of FIG. 2, four motion control devices via a known connecting means. Examples of the motion control devices include other identical or equivalent actuators as well as other motion control devices that can be utilised within such a control network for example, cameras, sensors grippers etc. Similarly, the connection means 3 for connecting the motion control devices, which may be actuators, or for internally transferring power and communications from the actuator housing 1 to the actuator shaft 2 at the connection points 14, 15, may, for example, be cables, towing devices, slip rings or other similar components. The most preferable connection means 3 for transferring power and communications from the static actuator housing 1 to the rotating actuator shaft 2, or to the static actuator housing 1 from the rotating actuator shaft 2, are slip rings. These slip rings may be of any type including wireless slip rings which transfer power and communication signals via an electromagnetic field created by coils placed in each part of a two part slip ring, one part of the slip ring may be located on the actuator housing 1 while the other may be located on the actuator shaft 2. Cables or other such components may be better suited to transferring power and communications between actuators or other devices within the network. The connection points 14, 15 are points of connection between the actuator housing 1 and the actuator shaft 2. Power and communication signals are transmitted between the actuator housing 1 and actuator shaft 2 at these connection points 14, 15, via connection means 3 which may be located at the connection points 14, 15 and provide the means to transmit the power and communication signals. The number of connection points 14, 15 may be different from the number of connection ports 17. The connection points 14, 15, and consequently connection means 3, may consist of at least two connection lines; the connection lines must have at least one communication line and a power line, where the power line may be a voltage line.

The actuator having at least one connection port 17 on the actuator housing 1 and at least one connection port 17 on the actuator shaft 2 allows the described actuator to act as a network hub for other motion control devices within the network. Acting as a hub, power from the power source and communication signals may be transmitted through the electrical actuator and supplied to one or more other motion control devices that are connected to the network.

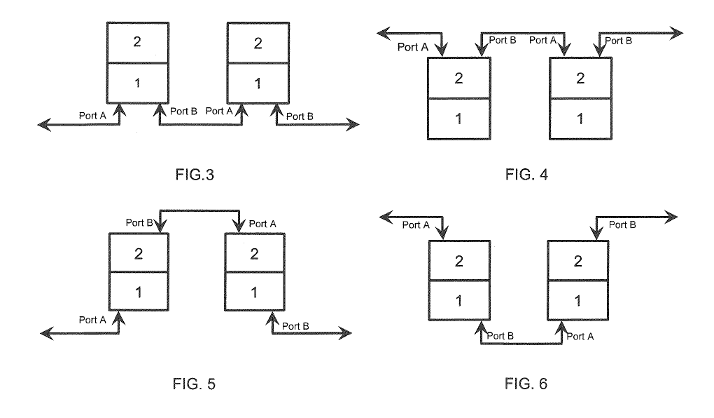

FIGS. 3 to 6 demonstrate some examples of possible connection scenarios between two actuators configured with connection ports 17 on both the actuator housing 1 and actuator shaft 2, as previously described. As may be demonstrated in FIGS. 3 to 6 the actuators are not limited to being coupled such that the power and communication signals are forced to traverse the rotation boundary between the actuator housing 1 and actuator shaft 2. The actuators may be connected in a number of different combinations such as housing 1 to housing 1, housing 1 to shaft 2, shaft 2 to housing 1 and shaft 2 to shaft 2 and via any unused/available port 17. Multiple actuators may be connected in the manner shown in FIGS. 3 to 6, such that actuators may be connected to both the actuator housing (1) and the actuator shaft (2) at the same time.

The use of multiple connection ports 17 on the actuator and the ability of network devices to connect to any port 17 allows the network designer the freedom to create many different network topologies. Different network topologies may be better suited to particular scenarios depending on where they are employed; thus, the actuators of the described system provide the designer with the customisability to choose the network topology that will best suit their use. Some examples of possible network topologies which the network may take are: a fully connected topology, tree topology, ring topology, linear topology etc. One specific example could be that the motion control devices are connected in series in a “daisy chain” formation. Of course, the topology of the network may not be limited to these examples and may incorporate a number of such example topologies or others as a hybrid system if the designer so wishes.

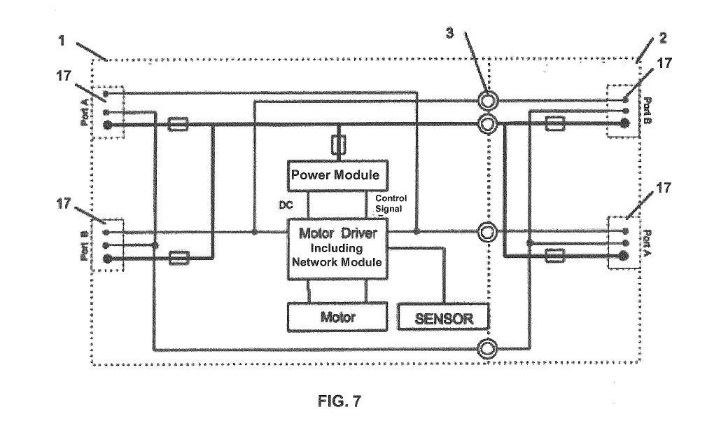

The internal circuitry and components of the electrical actuator will next be described in relation to FIGS. 7 to 9. Power and/or communication signals are input to and output from the electrical actuator via any of the connection ports 17, “A”, “B”, “C”, “D”; this may be via one of the connection points 14, 15 and due to the high voltage and/or current of the power input, for example 400-800 VDC 10-2000 W, the power and communication lines may be necessarily separate so that the signal may not be lost within the power line. As seen in FIGS. 7 to 9 each connection port 17 may have more than one connection line; power and communication lines may be combined or separate. Not more than one network device or connection means 3 may be connected to the same connection port 17; for example, if an actuator is connected to connection port 17, “A”, one of the other ports 17, “B”, “C” or “D” must be used to connect the next device or actuator as a port 17 can only be used once. High power lines are inherently very noisy and as such communication signals which are desired to be transferred along with the power, can become lost and hard to accurately distinguish from the noise. One of the advantages of using two separate inputs for the power and the communication signals is that any communication signal or the like which may be desired to be transferred around the network and to the actuators can still be easily and accurately identified; high power may also be provided to each component. If the actuator may be desired to be run at a low torque, such that a high power requirement may not be necessary, the power and signal inputs may be combined; thus allowing for a further simplified network configuration. A line of redundancy 16 is provided which directly connects the connection ports 17; this allows power and communication signals to pass through the actuator without passing through any components, other than the connection means 3 between the actuator housing 1 and actuator shaft 1.

The high DC power input to the actuator, which may enter via any connection port 17, travels through the power lines into the actuator housing 1 and then to the power module 4, which isolates the actuator from the power source. Examples of the power source may be a power grid, battery 30 or other such source of high voltage. Fuses 26 and 27 can be provided on the power lines, to provide safe guards against undesired power anomalies; thus, protecting the internal components of the actuator, and the network as a whole, from dangerous and undesired power surges.

The power module 4 can then manage the high power, i.e. voltage, from the connection ports 17, or other source such as a battery 30, and continuously distribute the power to a different connection port 17 to that of the input power; thus powering another device. Only power needed to run the components of the actuator may be extracted from the total power input. The power module 4 of the actuator may convert the high voltage input so that the power is adapted to be used by the motor driver or other components such as the network module 35, sensor 29 etc.; thus providing an operating voltage for these components. The power module 4 may do this by reducing the voltage to provide an operating voltage as, for example, a step down transformer would. In one possible example the power module may convert the power supply from AC to DC or alternatively from DC to AC. Operable DC power may be then supplied from the power module 4 to the other components within the actuator; preferably the power module 4 may be connected directly to the motor driver and/or network module 5, 35, 36 which in turn supplies power to the motor 6a, actuator sensor 29 or similar components. The direct connection with the motor driver and/or network module 5, 35, 36 allows the power module 4 to receive and transmit control signals to and from the motor driver and/or network module 5, 35, 36. Alternatively, power may pass through the electrical actuator, from one connection port 17 to another without passing through the power module 4 and thus any further internal components of the actuator.

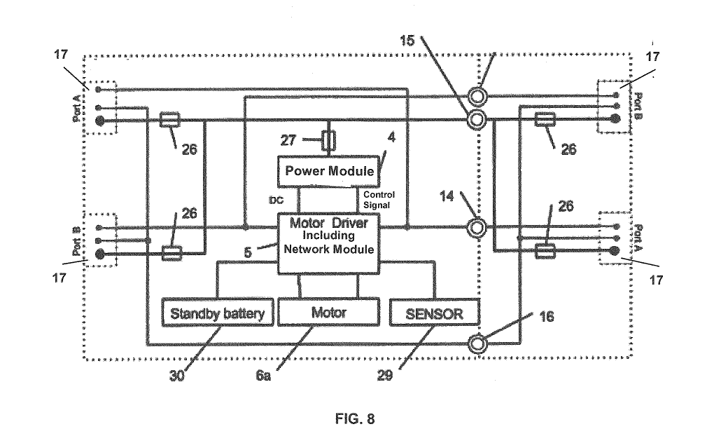

Communications signals received from any of the ports 17 on either the static actuator housing 1 or on the rotating actuator shaft 2 may then be transmitted into the actuator housing 1 and then directly to the network module 35 which, as shown in FIGS. 7 and 8, can be combined with the motor driver into one component 5. In this configuration the motor driver may be combined with the power module instead of the network module into one component 5. This allows for a reduction in the number of components when compared to other network based devices as well as reduction in overall size of the actuator as the control circuitry inside may be smaller. The network module 5, 35 serves to receive communication signals from the ports 17 and distribute the appropriate instructions to each of the components in the device, either directly or via another component, as well as other devices within the network. Communication signals are transmitted and received by all components of the actuator and serve to provide the control instructions to each of the components.

After receiving the communication signals from at least one of the ports 17, the network module 5, 35 can instruct the power module 4 to extract only the necessary power from the total input power, so as to perform the instruction received on the communication signal. The motor driver and network module 5, 35, 36 then receive an operating voltage from the power module 4 which can be distributed to the further components of the actuator such as the electric motor 6a or actuator sensor 29. The motor driver may be combined with the power module instead of the network module into one component 5. Once the motor driver 5, 36 receives the correct voltage from the power module 4, it will drive the electric motor 6a such that the desired action of the control network may be performed. The actuator sensor 29 may be provided within the actuator housing 1 and may be connected to the motor driver 5, 36, this sensor 29 may monitor the efficiency, thermal performance and other properties. One example of such a sensor 29 may be a Magnetic Position Sensor 29 which could provide angle measurements without having to calculate shaft 2 position. Other examples of sensors which may be used include, different temperature sensors, a motor current sensor for torque sensing, a humidity sensor, a water leakage sensor or other such appropriate sensors for monitoring the actuator.

In addition to the power module 4, the motor driver and network module 5, 35, 36 may, in some configurations, also be connected to a standby battery 30 within the actuator housing 1. This provides a level of redundancy, if for some reason, the power module 4 cannot draw power from an external grid, via the connection ports 17, or if the actuator is not connected to anything. The battery 30 may also be used, for example, to allow the actuator the ability to perform a predefined emergency task if the power and/or communication connections are lost from an external source.

As previously described, there may be at least one connection port 17 on each of the static actuator housing 1 and the rotating actuator shaft 2, such that the power and communication signals can be transmitted between the rotating and the non-rotating parts of the actuator. As the actuator housing 1 and shaft 2 rotate independently of each other, slip rings 3 may be provided on the interface between the housing 1 and the shaft 2, thus allowing the power and communication signals to be transferred between the two sides of the rotation of the actuator. The advantage of providing slip rings 3 internally at the connection points 14, 15 may be that the actuator can provide continuous rotation while continuing to transfer power and communication signals; thus applications such as manipulator arms are not hindered by limited rotation angle. Using slip rings 3 also creates a more durable system as cables and wiring will not be put under strain due to continuous rotation; thus leading to wear and possible broken connections.

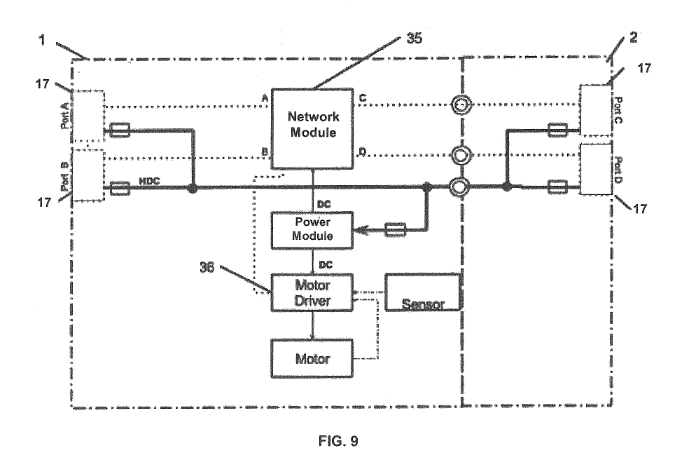

FIG. 9 demonstrates a slightly simplified control circuit configuration within the actuator housing 1 which may be similar to that of FIGS. 7 and 8, however, the motor driver 35 and network module 36 are not combined into the same component 5. The motor driver may or may not also be combined with the power module instead of the network module into one component 5. In this example configuration communication signals are input from the connection ports 17 “A”, “B”, “C”, “D” to the network module 35; the network module 35 may then send a control signal to the power module 4 instructing it how much power is needed to drive the motor 6a for the desired action. The power module 4, may then extract only the necessary power from the power input from the connection ports 17 and provide this power to the motor driver which in turn may provide power to the sensor 29 and drive the electric motor 6a. Further communication lines are shown directly connecting the motor driver 36 with the network module 35 as well as the sensor 29 and electric motor 6a. In this example configuration, only connection means 3 for three connection lines are needed the four of the previous example as no redundancy line 16 is present.

It should be understood that features of both examples can be combined and are interchangeable, for example, the network module 35 and motor driver 36 may be separate components in the first example but combined into one component 5 in the second example. Additional modules may also be added to the control circuitry to improve the monitoring of the components and provide further redundancies. In FIGS. 7 to 9, only one of the connection means 3 is labelled as it is obvious that the other three, seen in FIGS. 7 and 8, or two, seen in FIG. 9, are the same component. The same is true of the connection points 14 and 15 where the connection means 3 are located. In the example of FIG. 9 no redundancy line 16 is present, however, it should be understood that this could be included in any example should the user wish; thus allowing added reliability to the actuator.

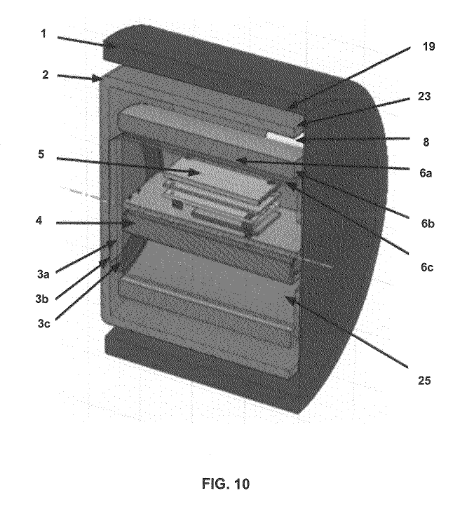

The compact configuration of the electrical actuator can be seen in FIG. 10, where the control circuitry, including the motor driver combined with the network module 5 as well as the power module 4, are shown at the centre of the electrical actuator. The slice taken through the actuator of FIG. 10 is along centre axis 25 of the actuator. It can be seen that the actuator shaft 2 may be sized approximately to have a diameter only marginally smaller than that the actuator housing 2 along at least one axis.

The electrical motor 6a, rotor 6b and stator 6c are positioned in the actuator housing 1 such that when the voltage from the power module 4 via the motor driver 5, 36 may be applied to the stator 6c a flow of current may be induced in the motor rotor 6b. The interaction of the stator 6c and the rotor 6b creates a magnetic field which results in motion of the motor 6a. The actuator employs an outer rotor motor 6a system wherein the rotor 6b may be located outside the stator 6c, as opposed to the conventional setup in which the rotor 6b may be located inside the stator 6c. The rotor 6b may be formed of permanent magnet segments or a moulded ring fixed to the inside of a cup/the actuator housing 1 around the electric motor shaft 2. The increased inertia of the outer rotor motor 6a configuration also reduces cogging, lowers audible noise and provides more stability at lower speeds. A further advantage is that electric motors with rotors external to their stators 6c are axially shorter than those with internal rotors while maintaining the same performance levels; thus, the whole system can be reduced to a more compact size.

An advantage of the presently disclosed actuator is the two-way bi-directional transmission of voltage and communication signals via internal slip rings 3 consisting of two parts, a shaft side 3b, and a housing side 3c. These parts can rotate around one another about a common axis on which each of the parts has a surface which may abut that of the other allowing sliding against each other as the motor shaft 2 rotates in relation to the actuator housing 1. The two parts of the connection means 3 are located inside the actuator housing 1 wherein one part 3c of the slip ring 3 may be attached to the actuator housing 1 and the other part 3b may be attached to the actuator shaft 2. This two-way bi-directional transmission of power and communication signals may be split such that separate connecting means 3 may be used for communication signals and the transmission of voltage. These slip rings may be wireless slip rings which may transfer power and communication signals via an electromagnetic field. This feature allows the power and communication signals to be transferred across the rotation divide between the actuator housing 1 and the actuator shaft 2, thus allowing devices to be connected to both or either the static actuator housing 1 and the rotating actuator shaft 2. The ability to connect devices to both sides of the rotation, provides a number of advantages amongst which may be that the network topology can have greater customisability as well as serving to reduce the number of overall components and wiring internally and externally to the actuator when compared to currently available devices.

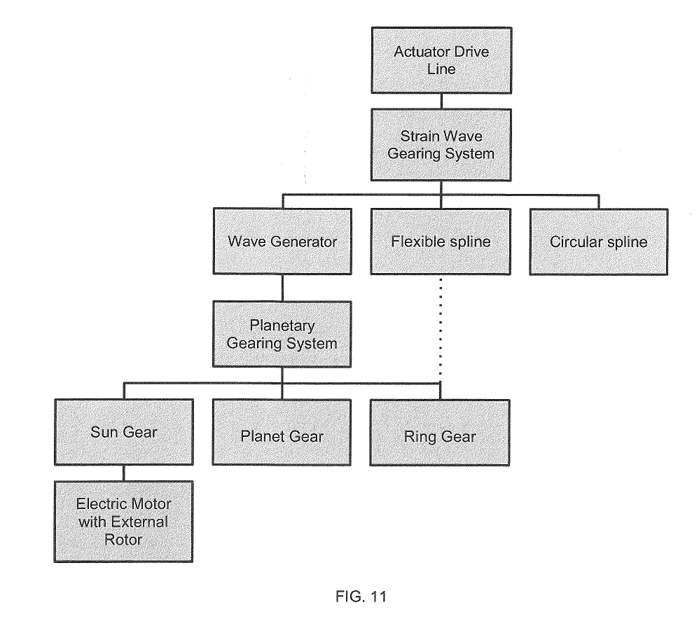

FIG. 11 depicts one possible general configuration utilising the electric motor 6a with external rotor 6b, as described above. In this configuration, the electric motor 6a with external rotor 6b, can be employed as a sun gear 21 at the centre of a planetary gearing system 11 further comprising two or more planet gears 8 with a ring gear 10 encasing the planet gears 8 and the sun gear 21. This planetary gearing system 11 may act as wave generator 22 at the centre of a strain wave gearing system 18. The wave generator 22, formed of the electrical motor 6a, rotor 6b and stator 6c and planet gears 8, may have an asymmetrical oval shape; this asymmetrical oval shape, along the major axis, means that the shape of the wave generator is semi-elliptical and semi-circular in shape with the two halves divided by the major axis. In this configuration, the wave generator 22 may engage the flexible spline 23 which then conforms to the shape of the wave generator 22. The flexible spline 23 may then engage the circular spline 19 (actuator housing 1) using a single contact zone and a single non-contact zone as opposed to two diametrically opposed non-contact zones located along the minor axis of the wave generator 22 and thus flexible spline 23. This design serves to reduce the wear on the teeth during rotation, increase the torque and gear ratios possible which would be extremely advantageous in a providing an electrical actuator which is a viable alternative to hydraulic and pneumatic actuators. If the asymmetric shaped wave generator 22 is combined with the planetary gear system 11, this asymmetry may be balanced or cancelled out using different weighting on the planet gears 8 (different sized planet gears 8) such that the wave generator may take a regular oval shape again.

In strain wave gearing system 18 the wave generator 22 may be inserted into the flexible spline 23, however, when the wave generator 22 comprises planetary gearing system 11, the ring gear 10 of the planetary system may act as the flexible spline 23 of the strain wave gearing system 18. When the wave generator 22, formed of the electrical motor 6a, rotor 6b and stator 6c and planet gears 8, is inserted into the flexible spline 23/ring gear 10, the outer teeth of the planet gears 8 engage with the inner tooth ring 9 flexible spline 23/ring gear 10. This flexible spline 23/ring gear 10 may then be inserted into the rigid circular spline 19, to complete the strain wave gearing system 18 and form the actuator drive line with the flexible spline providing the drive output of the actuator. The strain wave gearing system 18 alone will provide reduced backlash as well as increased gear ratios; however, a further advantage of using the combination of these two gearing systems is that the torque density can be greatly increased compared to using only one type of gearing system. This allows the electric actuator to be viable as a replacement to its pneumatic and hydraulic counterparts by achieving similar high torque output, for example 20-2000 Nm. Furthermore, the combination of these two gearing systems into one allows the number of components to be reduced when compared to classical gearing systems which achieve the same effect.

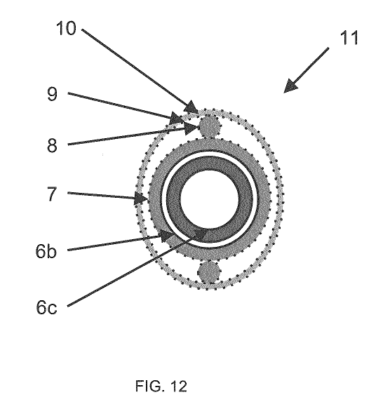

The first part of the gearing system is shown in FIG. 12 in and may be described with reference to a planetary gearing system 11. In this example configuration, moving concentrically out from the centre, the motor 6a stator 6c may be located within the external rotor 6b as described in relation to FIG. 10. A tooth ring 7 may be formed on the outer surface of the electric motor rotor 6b which may engage two or more planet gears 8; these in turn may engage the inner tooth circle 9 of the ring gear 10; thus forming the planetary gearing system 11 which may be combined at the centre of the strain wave gearing system 18.

The planet gears 8 within the planetary gearing system 11 of FIG. 12 are configured to have a lower diameter than that of the sun gear 21, however, it should also be understood that the planet gears 8 can be equal to the sun gear 21 in diameter. This particular configuration, wherein the planet gears 8 have been chosen to have a smaller diameter than the sun gear 21, provides the most compact configuration while allowing for the largest and consequently the highest torque electric motor 6a to be present. This also provides a larger space at the centre of the electric motor 6a with external rotor 6b such that the shaft of the electric motor can be of hollow construction which would allow the electrical circuitry, including motor driver and/or network 5, 35, 36, to be located within. This hollow shaft construction serves to maximise the space available within the actuator and to reduce the size by providing the necessary circuitry as well as other components in the most efficient and space saving manner. The shaft 2 may not be limited to hollow construction and may also be of solid construction depending on the intended use. A hollow shaft with the same diameter as a solid shaft allows the hollow constructed shaft to handle more torsional stress than a solid shaft, while also being lighter, there is reduced sheer stress at the inner most portion of the shaft.

In one example the planet gears 8 and sun gear 21 of the above configuration may be of gear bearing design which provides further increased efficiency due to reduced rolling friction. In such a design, the teeth of the wheels do not cover the whole of the edge of the wheel and a flat strip may be present either side of the teeth. Another type of gear bearing that may be used may be eccentrically cycloidal gearing; in this configuration, the teeth of the gears take on a screw thread like or helical pattern allowing high speed and low friction. This design allows a greater load capacity compared to regularly toothed gears and thus will assist in increasing the torque by allowing a larger load to be applied to the electric motor 6a of the actuator.

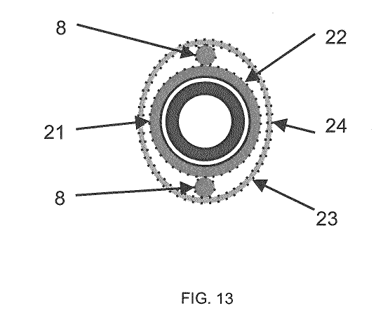

As discussed, the planetary gearing system 11 may serve to act as the wave generator 22 of the strain wave gearing system 18; to this end, FIG. 13 describes the planetary gearing system 11 of FIG. 12 in terms of the strain wave gearing system 18 terminology. In the strain wave gearing system 18 the wave generator 22 may be formed of a spherically shaped, asymmetrically oval shaped or symmetrically shaped, sun gear 21 (formed of the electric motor rotor 6b and stator 6c) with an outer tooth ring 7 engaging two or more planet gears 8 to complete the wave generator 22. This wave generator's 22 planet gears 8 engage the inner teeth 9 of a flexible spline 23. The flexible spline 23 may also be known as the ring gear 10 of the planetary system seen in FIG. 12; this flexible spline 23 may also have an outer tooth ring 24 and take the shape of the wave generator 22. The flexible spline 23 may be torsionally stiff so as to transmit high loads and allow for a higher torque density than may be conventionally possible from an electric motor 6a. The flexible spline 23 and wave generator 22 together form two of the three parts of the strain wave gearing system 18.

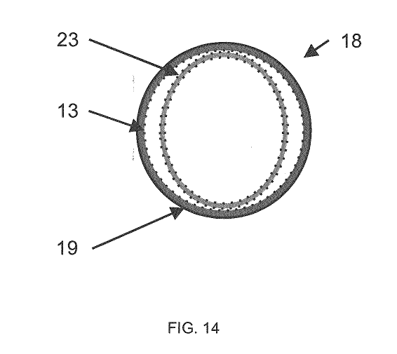

The oval shaped flexible spline 23 may then be inserted into a circular spline 19 (the third part of a strain wave gearing system 18); this for example may be the actuator housing 1, as shown in FIG. 14, which serves as a circular spline 19 should have at least one more tooth on the inner tooth ring 13 than those on the outer tooth ring 24 of the flexible spline 23. The inner part, wave generator 22, of the strain wave gearing system 18 has been omitted from this figure to provide a more simplistic understanding of how the strain wave gearing system 18 may be constructed. The assembled strain wave gearing system 18 has two tooth engagement areas. In a possible example these may be diametrically opposed around the centre axis 25 of the electric motor 6a. When the electric motor 6a with external rotor 6b rotates, the planetary gearing system 11, functioning as the wave generator 22, rotates; this rotation causes the flexible spline 23 to rotate in the opposite direction to the wave generator 22 and the outer tooth ring 24 of the flexible spline 23 to engage with the inner tooth ring 13 of the rigid actuator housing 1; the actuator housing 1 may serve the purpose of a circular spline 19. Due to the circular spline 19 having a greater number of teeth than the flexible spline 23, the flexible spline 23 and the circular spline 19 rotate relative to one another; this completes the strain wave gearing system 18 and forms the actuator drive line as depicted in FIG. 11.

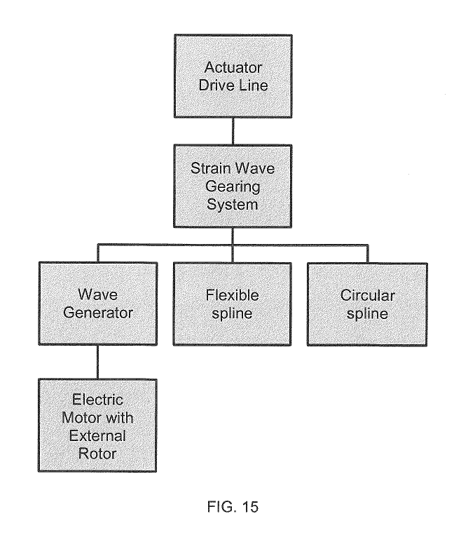

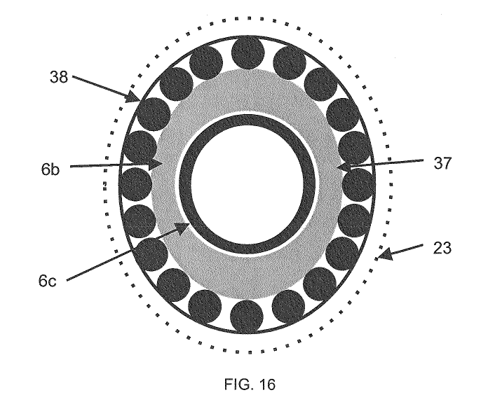

Although the actuator configuration has been described with a combination of gearing systems it should be also understood that the planetary gearing system 11 may be removed from the gearing system combination such that only the electric motor 6a with external rotor 6b and the strain wave gearing system 18 remains; as shown in FIGS. 15 and 16. The general configuration of a strain wave gearing system 18, for an electrical actuator, with an electric motor 6a at its centre, can be seen in FIG. 15. In this configuration, the external rotor 6b, outside the electrical motor 6a stator 6c, may be directly formed, in an oval shape 37 with associated oval ball bearings 38, as an integral part of the wave generator 22. Alternatively, as described in the previous example the wave generator 22 (in this example the wave generator 22 may comprise the electric motor 6a, stator 6c, rotor 6b and ball bearings 38 as seen in FIG. 16) and may also have an asymmetrical oval shape; this asymmetrical oval shape, along the major axis, means that the shape of the wave generator is semi-elliptical and semi-circular in shape with the two halves divided by the major axis.

The wave generator 22 may then be inserted into the flexible spline 23 in the same way as the wave generator 22 with the planet gears 8 was in the alternate configuration of FIGS. 12 to 14. The configuration of FIG. 16 reduces the number of components when compared to the previous configuration thus providing a simpler design which would be cheaper and easier to implement, while still providing a much higher torque output than standard electrical actuator configurations. Furthermore, the reduced number of components and simpler design would also serve to make the actuator as a whole more compact and reduce its size.

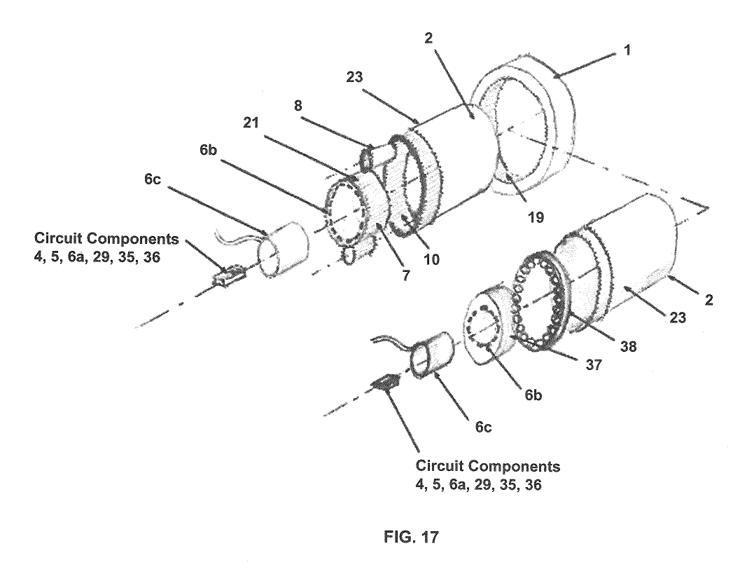

FIG. 17 demonstrates exploded depictions of the two configurations discussed and how each may be formed to fit inside the actuator housing 1. The exploded diagram demonstrates that both configurations are compatible with the actuator housing 1 and can be interchanged depending on the scenario in which the actuator may be desired to be employed. It can also be seen that the electrical components can be disposed within the stator 6c of the actuator; thus reducing the size, to for example 80-200 mm diameter and 80-200 mm length, of the actuator while maintaining the ability to provide a high speed electric motor within a low speed, high powered, high torque actuator. Example values of one possible actuator configuration which could be employed for any of the discussed examples could be torque of 20-2000 Nm, power of 10-2000 W, typical voltage 400-800 VDC with pass through power of 10-50 Amp and data communications of 100 mbps to 100 Gbps. These values are merely representative examples possible actuator characteristics and should not limit the actuator of the present disclosure to these values as other possible values corresponding to high power, torque etc. can be used depending on the user's needs. In some examples there may also be a hollow passageway through the entire centre axis of the actuator which may be smaller than the diameter of the shaft of the electric motor 6a such that the shaft of the electric motor may surround the passageway. This passageway may be used to run hydraulic hoses, cables or other similar components through the actuator.

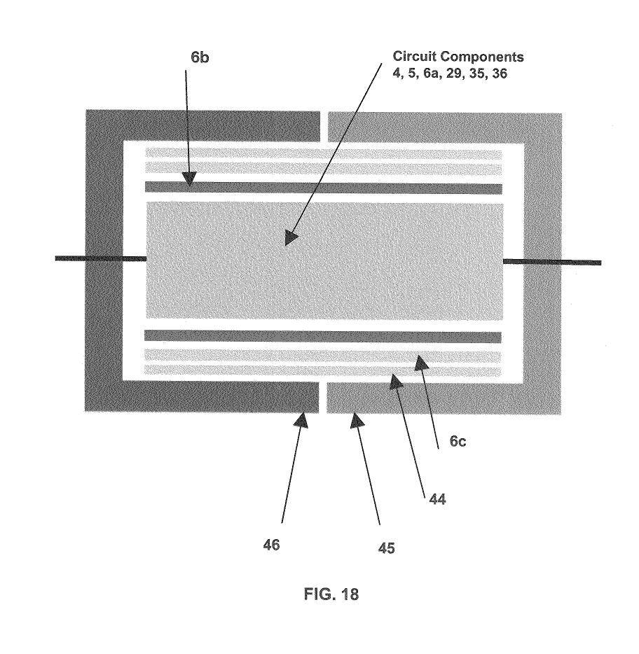

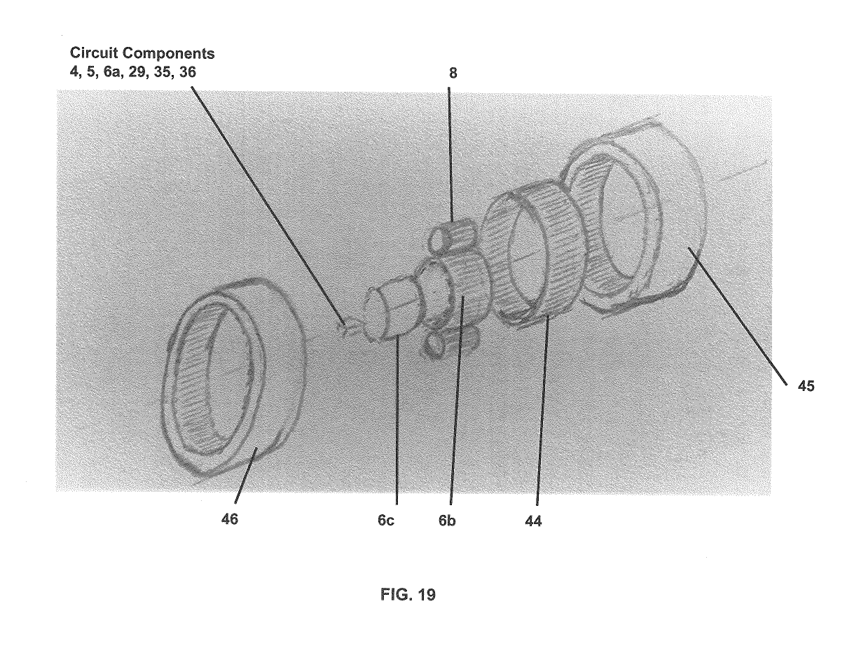

A further example of a strain wave gearing system 18 that may be used as part of the actuator drive line of this disclosure is seen in FIGS. 18 and 19. This strain wave gearing system is a pancake strain wave gear system. The wave generator 22 at the centre of which can be formed either with or without the planetary gearing system 11 as described in the previous examples relating to FIGS. 11 to 16. The wave generator 22 which may be an asymmetric or symmetric oval shape may engage the flexible spline 44 which may then conform to the same shape as the wave generator 22 as seen in previous examples. In this example the flexible spline 44 may not be the actuator shaft 2 but a separate component. This flexible spline 44 may then be inserted into two circular splines, a fixed circular spline 45 and a rotating circular spline 46; these two circular splines may, in this example, be the actuator housing 1 (fixed circular spline 45) and the actuator shaft 2 (rotating circular spline 46). Each of these circular splines covers half of the outer surface of the flexible spline 44. The rotating circular spline 46 may have the same number of teeth on its inner tooth ring as those of the outer tooth ring of the flexible spline 44 and rotates at the same speed as the flexible spline 44. The fixed circular spline 45 may have at least one more tooth on its inner tooth ring than that of the flexible spline 44 such that, similarly to the actuator housing 1 of the previous examples, the flexible spline 44 and the fixed circular spline 45 rotate relative to one another. The rotating circular spline 46 is thus the output member of the drive line; thus completing the strain wave gearing system of this example and forming the actuator drive line as depicted in FIG. 18. FIG. 19 demonstrates an exploded representation of the pancake strain wave gearing system of the actuator.

In one example a decentralized compact electric low-speed rotary actuator may be especially applicable to the construction of motion systems where the actuator together with identical or equivalent actuators or other network-based modules form a network. This actuator may be figured in line with the following points:

1. The actuator may comprise an actuator housing 1, actuator shaft 2, power module 4, network module 35 and motor driver 36, wherein the motor driver 36 may or may not include either the power module 4 or network module 35 to form component 5, electric motor 6a with external rotor 6b in combination with a strain wave gearing system 18 directly or in conjunction with planetary gearing system 11 and actuator sensor 29. The actuator supplied voltage and communication network can be transmitted between actuator housing 1 and actuator shaft 2; this may be done as the actuator shaft 2 rotates about the actuator centre axis 25 with cables or towed devices 3 carrying voltage and communication between actuator housing 1 and actuator shaft 2. The voltage and communications may be carried between the components independent of direction. The actuator may have two or more identical connection points 14, 15 for voltage and communication networks, at least one connection point 14, 15 in each of the main components, actuator housing 1 and actuator shaft 2. An electric motor 6a may be located in the centre of the strain wave gearing system 18 and may be an integral part of the wave generator 22 which may have an oval shape with associated oval bearings 38. Alternatively, the electric motor 6a may act as a sun gear 21, wherein the motor rotor 6b may have a tooth ring 7 running around its outer periphery in engagement with two or more planet gears 8. The planet gears may be adapted to engage the inner tooth ring 9 of the flexible spline 23 and may shape this to take an oval shape.

2. The actuator of point 1 which may also allow a two-way bi-directional transmission of voltage and communications 3a consisting of two parts 3b, 3c which can rotate around one another about a common axis. On the common axis each of the parts has a surface of an abutment 3b slider actuator housing side 3c that slides toward another. The two parts of the device are located inside the actuator housing 1, the part of the device 3c may be attached to the actuator housing 1 and part 3b may be attached to the actuator shaft 2.

3. The actuator of point 2 where the two-way bi-directional transmission of voltage and communication may be split such that, for example, a separate device is used for communication, another device is used for transmission of voltage.

4. The actuator of point 1 which may further include that voltage and communication networks can be connected to and or transmitted from any available connection port on actuator housing 1 and/or actuator shaft 2.

5. The actuator of any one of points 1 to 4 which may further draw power from a power source and can continuously distribute it to identical actuators, corresponding actuators or other network-based modules through their connection ports 17. The power source may be any high DC voltage power source, power grid and/or high voltage battery.

6. The actuator of any one of points 1 to 5 may also include that each connection point 14, 15 consists of at least one communication line 14 and a power line 15.

7. The actuator of any one of points 1 to 6 which may further include that the voltage module 4 may reduce the supplied voltage adapted to the motor driver 5, 36 and the electric motor 6a.

8. The actuator of any one of points 1 to 7 which may further include that the voltage module 4 isolates the actuator from the supplied power grid of the actuator.

9. The actuator of any one of points 1 to 8 which may further include that the number of connection points 14, 15 may be different to the number of connection ports.

10. The actuator of point 1 which may further include that the actuator voltage module 4, motor driver including network module 5 or separate network module 35 and motor driver 36 are located in the centre of the hollow rotor 6b of the motor 6a.

11. The actuator of point 1 which may further include that a motor driver including network module 5 is used, alternatively; the network module 35 in separate but in combination with motor driver 36

12. The actuator of point 1 which may further include that an electric actuator which, together with other electric actuators, can be connected in the daisy chain, in one or more of the following configurations actuator housing 1-actuator housing 1, actuator shaft 2-actuator shaft 2, actuator housing 1-actuator shaft 2, actuator shaft 2-actuator housing 1.

13. The actuator of point 1 which may further include that the electric motor 6a with external rotor 6b may be of hollow shaft construction.

14. The actuator of point 1 which may further include that the electric motor 6a with external rotor 6b may be of solid shaft design.

15. The actuator of any one of points 1 to 13 which may further include that the planet gears 8 have a lower diameter than the sun gear 21.

16. The actuator of point 15 which may further include that the planet wheel 8 is of a design that allows high speed and low friction.

17. The actuator of point 1 which may further include that the wave generator 22 has an asymmetrical oval shape.

18. The actuator of point 17 which may further include that asymmetric wave generator 22 in combination with planetary gearing system 11 is balanced using different weighting on the planet gears 8.

19. The actuator of any one of points 1 to 6 which may further include that the sun gear 21 and planet gears 8 have a bear gearing design.

20. The actuator of point 1 which may further include that the electrical components may be located in the centre of the hollow rotor 6b of the motor 6a. The electrical components may for example include the actuator voltage module 4, motor driver including network module 5 or separate network module 35 and motor driver 36

The actuator of the above configurations may also be split into two actuators one directed at solving the networking problems and one directed at solving the mechanical power and torque problems. The two actuators may be configured considering the following points.

Network Problem Actuator

1. The actuator may be especially applicable in networks with identical actuators, in networks with other corresponding actuators or in conjunction with other network-based modules. The actuator may include an actuator housing 1, actuator shaft 2, power module 4, motor driver including network module 5 or separate the network module 35 and motor driver 36, engine 6a and actuator sensor 29. The actuator supplied voltage and communication network may be transmitted between actuator housing 1 and actuator shaft 2. Cables or towing devices (slip rings) 3 may conduct voltage and communication independent of direction between the actuator housing 1 and actuator shaft 2. Furthermore; the actuator may have two or more identical connection points 14, 15 for voltage and communication networks. At least one connection point 14, 15 is located in each of the main components, the actuator housing 1 and actuator shaft 2.

2. The actuator of point 1 may further include a two-way bi-directional transmission of voltage and communication 3a consisting of two parts 3b, 3c which can rotate around one another about a common axis on which each of the parts has a surface of an abutment 3b slider actuator housing side 3c slides toward another, the two parts of the device are located inside the actuator housing 1, the part of the device 3c may be attached to the actuator housing 1, part 3b may be attached to the actuator shaft 2.

3. The actuator of point 2 which may further include that the two-way bi-directional transmission of voltage and communication is split such that, for example, a one device is used for communication signals while another device is used for transmission of voltage.

4. The actuator of any one of points 1 to 3 which may further include that voltage and communication networks can be connected to and/transmitted on any available connection port on actuator housing 1 and/or actuator shaft 2.

5. The actuator of any one of points 1 to 3 which may further include that the actuator tapes power from the supplied power supply and can continuously distribute it to identical actuators, corresponding actuators or other network-based modules through their connection ports 17.

6. The actuator of any one of points 1 to 3 which may further include that each connection point 14, 15 consists of at least one communication line 14 and a power line 15.

7. The actuator of any one of points 1 to 3 which may further include that the voltage module 4 reduces the supplied voltage adapted to the motor driver 5, 36 and the electric motor 6a.

8. The actuator of any one of points 1 to 3 which may further include that the voltage module 4 isolates the actuator from the supplied power grid of the actuator.

9. The actuator of any one of points 1 to 3 which may further include that the number of connection points 14, 15 may differ from the number of connection ports.

10. The actuator of any one of points 1 which may further include that the actuator voltage module 4, motor driver including network module 5 or separate network module 35 and motor driver 36 are located in the centre of the hollow rotor 6 of the motor 6a.

11. The actuator of any one of points 1 which may further include that a motor driver including network module 5 is used, alternatively; a separate network module 35 in combination with motor driver 36

12. The actuator of any one of points 1 which may further include that an electric actuator which, together with other electrical actuators, can be coupled in the daisy chain in one or more of the following combinations, actuator housing 1-Actuator housing 1, actuator shaft 2 actuator shaft 2, actuator housing 1 actuator shaft 2, actuator shaft 2 actuator housing 1.

Mechanical Problem Actuator

1b. An electrical actuator with high torque/volume ratio achieved by an electric motor 6a with external rotor 6b in combination with a strain wave gearing system 18 connected directly or in conjunction with a planetary gearing system 11. The electric motor 6a may be located in the centre of the strain wave gearing system 18 and may be an integral part of the wave generator 22 as an oval shape with associated oval bearings 38. Alternatively the electric motor 6a with external rotor 6b may act as a sun gear 21, whose motor rotor 6b has a tooth ring 7 around its outer periphery which may engage two or more planet gears 8 which in turn are adapted to engage an inner tooth ring 9 of a flexible spline 23 causing it to take an oval shape.

2b. The actuator of point 1b which may further include that the electric motor 6a with external rotor 6b maybe of hollow or solid shaft construction.

3b. The actuator of point 1b which may further include that the electric motor 6a with external rotor 6b may be of solid shaft design.

4b. The actuator of either of points 1b or 2b which may further include that the planet wheel 8 has a lower diameter than the sun gear 21.

5b. The actuator of point 4b which may further include that the planet gears 8 are of a design that allows high speed and low friction.

6b. The actuator of point 1b which may further include that the wave generator 22 has an asymmetrical oval shape.

7b. The actuator of point 6b which may further include that an asymmetrical wave generator 22 in combination with planetary gearing system 11 is balanced using different weight on planet gears 8.

8b. The actuator of point 3b which may further include that the sun gear 21 and planet gears 8 may be of bear gearing design

9b. The actuator of point 1b which may further include that the actuator voltage module 4, motor driver including network module 5 or separate network module 35 and motor driver 5 may be located in the centre of the hollow rotor 6 of the motor 6a.

The configurations discussed make it possible to provide a compact electrical actuator, capable of receiving high voltage power and supplying a large amount of torque at low speeds to rival outputs of pneumatic and hydraulic actuators and surpass current electrical actuator capabilities. The electrical actuator may do this by combining two gear systems to greatly increase the torque output from an electric motor 6a and providing the gearing system with a configuration that allows the actuator to remain compact by providing room for electrical components at the centre of the device. The electrical actuator may also be capable of forming a network of equivalent or other motion control devices by providing the ability to handle large power input to the actuator. This large voltage can be converted, for example stepped down, within the actuator before power may be provided to the components within the device; the actuator may be also capable of continuously distributing power and communication signals to other motion control devices which are part of the network. The ability to connect at least one other device to the actuator and to connect other motion control devices on both sides of the rotation, means that a number of network topologies can be created depending on the desired use; thus adding further to the versatility of the electrical actuator.

### REFERENCE NUMERALS

1 Actuator housing
2 Actuator shaft
3 Cables or Slip rings
3b Slip ring shaft side
3c Slip ring housing side
4 Power (Voltage) Module
5 Motor Driver including either network module or power module
6a Engine (Electric Motor)
6b Electric Motor Rotor/External Rotor
6c Electric Motor Stator
7 Outer Tooth Ring of Rotor
8 Planet Gear
9 Inner Tooth Ring of Flexible Spline
10 Ring gear
11 Planetary gearing system
13 Inner Tooth Ring of Circular Spline
14, 15 Connection Points
16 Redundancy Line
17 Connection ports
18 Strain wave gearing system
19 Circular Spline
31 Sun gear
23, 44 Flexible Spline
24 Outer Tooth Ring of Flexible Spline/Ring Gear
25 Actuator Centre Axis
26, 27 Fuses
29 Sensor
30 Standby Battery
35 Network Module
36 Motor Driver
37 Oval Rotor
38 Oval Bearings
45 Fixed Circular Spline
46 Rotating Circular Spline

1-39. (canceled)

40. An electric actuator for use as part of a network, the actuator comprising:
an actuator housing in which an actuator shaft is rotationally held,
a plurality of components comprising:
at least one power module, one network module and one electrical motor with external rotor, where the electric motor with external rotor is driven by a motor driver, form control circuitry located within the actuator housing
two or more connection ports each adapted to receive an electrical connector to transmit and receive power and control signals to and from the actuator, wherein each of the actuator housing and actuator shaft has at least one connection port;
two or more connection means adapted to transmit power and control signals bidirectionally between one or more of the components and the at least one connection port within the actuator housing and the at least one connection port on the actuator shaft, wherein each of the actuator housing and actuator shaft has at least one connection means,
wherein the connection means are slip rings,
wherein the actuator forms a strain wave gearing system comprising a wave generator, flexible spline and at least one circular spline, and
wherein the electric motor with external rotor with ball bearings around outer surface of the rotor forms the wave generator.

41. The actuator of claim 40, wherein the motor driver is either combined with the power module or network module to form a single unit, or the motor driver, network module and power module are present as separate components.

42. The actuator of claim 40, wherein the actuator shaft rotates about the actuator centre axis.

43. The actuator of claim 40, wherein the actuator shaft is the flexible spline and the actuator housing is the circular spline.

44. The actuator of claim 40, wherein the wave generator is formed of a planetary gearing system comprising a sun gear and planet gears, the sun gear formed of the electric motor with external rotor wherein the external rotor has a tooth ring around its outer surface which engages two or more planet gears, planet gears which engage the inner tooth ring of the flexible spline.

45. The actuator of claim 40, wherein the external rotor is of asymmetric oval shape or symmetric oval shape or symmetric spherical shape.

46. The actuator according to claim 40, wherein the each slip ring has separate power and communication connections.

47. The actuator according to claim 40, wherein each connection means consists of at least one communication line and one power line.

48. The actuator according to claim 40, wherein the actuator is configured to receive power from a first connection port or internal power source and continuously distribute the power via a second connection port to another device in the network using a connection means.

49. The actuator according to claim 40, wherein the power module is adapted to isolate the actuator from the power source and/or converts the supplied voltage adapted to the motor driver and the electric motor.

50. The actuator according to claim 40, wherein the number of connection means are different from the number of connection ports.

51. The actuator according to claim 40, wherein the electric motor with external rotor is of hollow shaft construction wherein the actuator components are located within the hollow shaft, preferably on the centre axis of the hollow shaft.

52. The actuator according to claim 40, wherein the planet gears have a smaller diameter than the sun gear.

53. The actuator according to claim 40, wherein the planet gears are of eccentrically cycloidal design that allows high speed and low friction or the sun gear and planet gears have a gear bearing design.

54. The actuator of claim 40, wherein the wave generator has an asymmetrical oval shape.

55. The actuator according to claim 56, when a planetary gearing system is used the asymmetry of the wave generator cancelled using different weight on planet wheels.

56. A network comprising two or more actuators according to claim 40, wherein the actuator can form part of a network via a connection means, preferably cables.

57. An electric actuator of claim 40 comprising:
an actuator housing in which an actuator shaft is rotationally held,
a strain wave gearing system comprising a wave generator, flexible spline and at least one circular spline, wherein the actuator shaft is the flexible spline and the actuator housing is one circular spline,
an electric motor with external rotor within the actuator housing configured to drive the gearing system,
two or more connection means between the actuator housing and the actuator shaft adapted to transmit the power and control signals;
the wave generator of the strain wave gearing system is formed of either the electric motor with external rotor with ball bearings around the outer surface of the rotor; or,
the wave generator of the strain wave gearing system is formed of a planetary gearing system comprising, a sun gear and planet gears, the sun gear formed of the electric motor with external rotor wherein the external rotor has a tooth ring around its outer surface which engages two or more planet gears, planet gears which engage the inner tooth ring of the flexible spline
wherein the connection means are slip rings.

58. The actuator of claim 57, wherein the external rotor is of asymmetric oval shape or symmetric oval shape or symmetric spherical shape.

59. The actuator of claim 57, wherein the actuator shaft rotates about the actuator centre axis.

60. The actuator of claim 40, wherein the actuator further comprises a plurality components comprising:
at least one power module, one network module and one motor driver.

61. The actuator of claim 40, wherein each of the actuator housing and actuator shaft has at least one connection means.

62. The actuator of claim 40, wherein the connection means are adapted to conduct power and control signals bidirectionally between one or more of the components in the actuator housing and the connection ports on the actuator shaft.

63. The actuator according to claim 40, wherein the actuator has two or more connection ports each adapted to receive an electrical connector to transmit and receive power and control signals to and from the actuator, wherein each of the actuator housing and actuator shaft has at least one connection port.

64. The actuator according to claim 40, wherein the actuator is configured to receive power from a first connection port or internal power source and continuously distribute the power to a second connection port to another device in the network using a connection means.

65. The actuator according to claim 40, wherein the each slip ring has separate power and communication connections.

66. The actuator of claim 60, wherein the motor driver is either combined with the power module or network module to form a single unit, or the motor driver, network module and power module are present as separate components.

67. The actuator of claim 40, when the planetary gearing system is used, wherein the planet gears have a smaller diameter than the sun gear.

68. The actuator of claim 40, when the planetary gearing system is used, wherein the planet gears are of eccentrically cycloidal design that allows high speed and low friction or the sun gear and planet gears have a gear bearing design.

69. The actuator of claim 40, wherein the wave generator has an asymmetrical oval shape.

70. The actuator according to claim 40, when the planetary gearing system is used the asymmetry of the wave generator cancelled using different weight on planet wheels.

71. The actuator according to claim 40, wherein the electric motor with external rotor is of hollow shaft construction wherein one or more of the actuator components are located within the hollow shaft, preferably at the centre of the hollow shaft.

72. The actuator according to claim 40, wherein each connection means consists of at least one communication line and one power line.

73. The actuator according to claim 40, wherein the power module converts the supplied power adapted to the motor driver and the electric motor.

74. A network comprising two or more actuators according to claim 40, wherein the actuator can form part of a network via a connection means, preferably cables.
